(19) United States
(12) Patent Application Publication
(10) Pub. No.: US 2022/0112113 A1
(43) Pub. Date: Apr. 14, 2022

(54) METHOD AND DEVICE FOR IMPROVING SLUDGE BIODEGRADABILITY

(71) Applicant: Orege, Voisins-Le-Bretonneux (FR)

(72) Inventors: Patrice Capeau, Ansouis (FR); Pascal Gendrot, Le Vesinet (FR)

(21) Appl. No.: 17/418,196

(22) PCT Filed: Dec. 24, 2019
(86) PCT No.: PCT/EP2019/087032

§ 371 Date: Jun. 24, 2021

(30) Foreign Application Priority Data
Dec. 26, 2018 (FR) FR1874159

(51) Int. Cl. C02F 11/00; B01F 25/312; B01F 23/232; B01F 23/80; B01F 25/51

(52) U.S. Cl. CPC C02F 11/00; B01F 25/31241; B01F 25/312533; B01F 25/31251; B01F 23/2323; B01F 23/803; C02F 11/04; C02F 2303/06; C02F 2209/38; C02F 2209/40; C02F 2301/046; C02F 2301/066; B01F 25/51

(57) ABSTRACT

The invention relates to a method and a device for improving the biodegradability of an organic sludge. It comprises at least two treatment cycles each of a total duration of between around 8 s and around 20 s and each comprising a first step of producing a first hydrolysed sludge emulsion in a first, reduced zone, by injecting a gas into said reduced zone. a second step of abruptly expanding the emulsion in a second zone—the expansion zone—and a third step of recovering the emulsion via a third, restriction zone.

The present invention relates to a process for improving the biodegradability of liquid organic sludge.

The term “organic sludge” refers to sludge containing at least 10% organic matter.

It also relates to a device implementing such a process and the intermediate product obtained.

It has a particularly important, although not exclusive, application in the field of methanization and more particularly in the production of biogas suitable for transformation into heat, electricity and/or vehicle fuel.

Sludge disintegration processes are already known, for example used as pretreatment before anaerobic digestion.

The objective of these techniques is to solubilize the particulate organic matter and reduce the size of the bacterial flocs.

However, these mechanical or chemical techniques have their drawbacks.

In particular, they perform inadequately due to oxidation reactions generating the appearance of non-biodegradable refractory organic substances, which leads to the opposite effect of that sought.

For example, preparation techniques using ultrasound action on sludge are known. However, these will generate cavitation phenomena at the molecular level and, therefore, very high pressures/temperatures which cause oxidation by producing free radicals.

There are also thermal hydrolysis techniques. While these may be more powerful, they are however expensive in terms of facility and operation, and/or require heating at high temperatures (160 to 180° C.).

In summary, all these techniques are expensive and have the disadvantage of producing non-biodegradable refractory organic substances which, therefore, have the opposite effect of that sought.

Finally, the efficiency of sludge preparation processes is linked to the initial load of the sludge in total solids (TS).

Thus, in the case of mechanical lysis techniques with local or chemical action such as those mentioned above and implementing ultrasound or chemical oxidation, the maximum load recommended is 6 to 8 g per liter TS, which necessarily entails the design of a large preparation facility.

Concerning thermal hydrolysis techniques, for which the initial concentration for an optimized treatment is of the order of 20 g per liter, any lower concentration generates additional costs, which again poses problems of space, homogenization and price.

The present invention aims to overcome these disadvantages by improving, among other things, the possibilities of reconditioning and/or reusing sludge thanks to a treatment that meets the requirements of practice better than those previously known, in particular in that it improves biodegradability in an astonishing way thanks to an increase in the dispersion of organic matter in the water mass, all associated with a significant lysis of the bacteria and a dispersion of the EPS and bacterial colonies, so that the colonization of the medium is facilitated and/or accelerated. At the same time, a decrease in the viscosity of the treated sludge is observed.

Such a result is achieved economically by a small device.

To this end, the present invention proposes in particular a process for improving the biodegradability of organic sludge comprising at least two successive treatment cycles, each cycle having a total duration comprised between the order of 8 s and the order of 20 s, for example of the order of 10 s, each cycle comprising a first step of creation of a first hydrolyzed sludge emulsion in a first zone, called the reduced zone, by injection of a gas into said reduced zone, a second step of sudden expansion of the emulsion in a second zone, called the expansion zone, and a third step of recovery of the emulsion via a third zone, called the restriction zone.

The process according to the invention does not involve any addition of additional flocculant.

In other words, no flocculant is injected, only the treatment by successive restriction/expansion, without any flocculation step by addition of polymer or other, allowing the exceptional results as described hereafter to be obtained.

This results in more efficient contact times, because they are not disrupted by additional materials between gas and sludge, with a duration that is a multiple of the basic time, for example 10 s (three times 10 s for three cycles).

The expression “of the order of” means±10% to 20%.

The invention also proposes a process for improving the biodegradability of liquid organic sludge comprising a first step of creation of a first hydrolyzed sludge emulsion in a first zone, called the reduced zone, of first relative pressure P1, by injection of air into said reduced zone by imparting to the sludge in said reduced zone a first velocity V1≥20 m/s, a second step of sudden expansion of the emulsion thus created in a second zone, called the expansion zone, with a second relative pressure P2 greater than 2 bar, and a third step of recovery of the emulsion via a third zone, called the restriction zone, by imparting to said emulsion in said restriction zone a second speed V2≥20 m/s.

It is known that organic sludge is a suspension of non-consumed organic matter, cations and bacterial structures organized in colonies, aggregates or isolated bacteria.

This is referred to as autoflocculation of the suspension. Indeed, living organisms form flakes of organic and mineral matter that are difficult to break mechanically and difficult to penetrate by other living bacteria.
But no addition of flocculant is performed, which has the advantage of limiting costs and not generating additional pollution.

The process according to the invention thus allows, in particular by exerting mechanical constraints, from an incompressible viscous fluid constituted by the organic sludge to be treated, the production of a compressible fluid comprising bacteria and bacterial flocs which can then be subjected to relatively mild pressure/counter pressure, which are observed, on the one hand, to sufficiently destroy (lyse) a part of the bacteria present in the sludge in an unexpected way and, on the other hand, to break the bacterial flocculation and disperse the organic matter, thereby allowing a greater biological availability of the latter subsequently, as for example in a digestion process that follows by anaerobic bacteria.

In other words, the process improves the biodegradability of these substances in that it crumbles, disperses, explodes the bacterial structure, making the material much more accessible to new strains.

Advantageously, the first zone, called the reduced zone, is an element of small diameter d (d<50 mm) wherein the sludge passes at a first high speed V1 (V1≥20 m/s) and at a low pressure p1, an element into which gas or air is injected at a high flow rate (for example at a flow rate q Nm³≥10 Q m³, Q being the sludge flow rate), to create the gaseous, compressible emulsion which then feeds the second zone, or reactor, downstream, of larger diameter D (D>20 d) than the element in which the emulsion passes, at a higher pressure P2 (P2>P1), for example P2>3 bar, and advantageously P2≥10 bar and <20 bar or 15 bar), and at a lower speed v (v<10 V1), before undergoing a pressure drop in the downstream member, for example formed by a ball valve or a globe valve or a plug valve, by imparting to said emulsion in said restriction zone a second velocity V2≥20 m/s. The particularly small size of the injection zone (for example 0.001 m³) will allow an excellent slurry/air mixture.

There is therefore indeed a high-velocity zone at this point, leading to kinetic impacts, which allow the sludge to burst into the gas.

Advantageously the gas used is air.

The presence of oxygen in the air further improves the constitution of an air/bacterial floc emulsion by bringing a level of dissolved oxygen and oxygen in the form of air bubbles allowing even better support of bacterial proliferation.

Bacterial growth in a Petri dish proves that the passed sludge becomes highly biodegradable.

Advantageously, the initial step is repeated on the hydrolyzed emulsion obtained successively at least N times with N≥2, for example N≥3 and/or N≥7 or 8.

The physical structure of the emulsion thus evolves as it passes successively (N times) through pressure and decompression stages and thus generates a phenomenon favorable to the biodegradability of the sludge and to the formation of bubbles of different sizes, namely small bubbles resulting from the gas or air dissolved at the pressure of the second zone, and larger bubbles resulting from the enlargement linked to the depression of the existing bubbles in the second zone (reactor).

It is observed that this stable emulsion is very favorable to the flotation of the mass and can if necessary produce a flotation of the latter.

A decrease in viscosity with each pass is also observed.

This low viscosity and the presence of residual gas bubbles in the sludge (even after degassing) allows it to be easily pumped, which is necessary for a good repetition of the cycles.

Furthermore, the invention, on the one hand by increasing the TS density, and on the other hand by preserving a good viscosity, will thus allow a better mixing and a regularity of feeding of the possible steps of the process which follow in continuous or semi-continuous mode.

The expression “semi-continuous mode” means, for example, successive batches, which are substituted one after the other on the fly, or substantially without stopping, to allow for continuous or semi-continuous processing, thus allowing for an excellent rate.

In summary, the pressure/depression actions described above improve the nature and structure of the organic matter, which is better dispersed and better lysed as far as the bacteria are concerned, which leads to a better accessibility and biodegradability of the organic matter by increasing the possibilities of exchanges and, therefore, for example in the case of a following methanization step, the yield of the digestion reaction and therefore of the methane production.

In advantageous embodiments, moreover and/or furthermore, one and/or the other of the following provisions is used:
the first zone being the central part of an elongated venturi around an axis parallel to the sludge feed direction, air is injected into said venturi obliquely with respect to the axis of the venturi;
the second average pressure P2 in the second zone is P2>3.5 bar and the third pressure P3 downstream of the restriction zone is atmospheric pressure;
the emulsion is strongly degassed after the third zone before repeating;
air is injected in the direction of the flow or against the flow of the sludge and/or injected at an angle comprised between 20° and 90°, for example between 20° and 50°, for example 30° with the direction of the sludge flow;
the excess gas is extracted by soft impact of the emulsion on itself or on an energy-absorbing flap, for braking the emulsion.

The term “energy-absorbing” means reducing the kinetic energy of the fluid by a factor of at least two.

This is a liquid/liquid type impact.

The term “soft impact” means a progressive impact or contact without percussion either on the emulsion itself by gravitational fall on itself for example, or on an energy-absorbing flap or wall or disk, for example a flexible flap or a flap of reduced size, for example of a few cm² (for example of x×y with x and y<10 cm), arranged to slow down the flow, without constituting an accident creating a sudden overpressure in the flow.

A flexible flap or wall is understood to mean an elastic or semi-rigid element, for example made of rubber or equivalent, capable of absorbing and/or creating a pressure drop, by braking, allowing degassing by pressure, without destroying the emulsion.

In other words, such a system allows the degassing of excess air while ensuring the continuity of the emulsion and the respect of the emulsion's passage or transfer speed during the process.

Furthermore, the energy used is provided by the kinetic energy of two flows, air and sludge, which are subjected to several sequences:
impacts at the entrance of a venturi, ejector, etc., type member (first zone, called the reduced zone) with different types of air introduction at 90°, 45°, propeller, etc.;
mixing in this member;
compression/depression sequence between this member and the reactor volume under pressure (second zone, called the expansion zone);
singular pressure loss due to the closing member, such as a valve (third zone, called the restriction zone);
and this, as has been seen, for the order of 10 s of contact time, advantageously repeatable N times with N≥2 or even N≥8.
   If necessary, oxidation such as ozone, hydrogen peroxide, persulfate, electrolysis, metal oxide or diamond can also be used, which produces an even stronger lysis of the membranes. But it is then necessary to control that the bacterial proliferation in culture is well boosted and not blocked by these additions.

It is observed that the process according to the invention leads to an improvement of the lysis of a few tens of percent of the bacteria in the medium, i.e., 10%, 20% or more.

This improvement of the lysis, which is carried out thanks to the macroscopic conditions of the medium containing the bacteria, is done under rather low local energy conditions, which avoids the undesired production of refractory organic molecules, often observed with the techniques of the prior art.

The biodegradability of the sludge can be measured, for example, by analyzing and comparing the bacterial proliferation capacity in agar culture, for example in a Petri dish.

The invention also proposes a device implementing the processes as described above.

It also proposes a device for improving the biodegradability of organic sludge comprising a pressurized in-line container or reactor, means for feeding the sludge continuously to the container comprising a sludge passage venturi, elongated around an axis, at least one air injection port in the constriction of said venturi, for injection at an angle with respect to the axis arranged to create an emulsion in the container and means for discharging the emulsion from said container via a member generating a pressure drop, and means for circulating said emulsion in a loop in the container by the sludge feeding means, upstream of the air injection.

Advantageously, the device has two air injection ports in the venturi at an angle comprised between 20° and 90° with respect to the axis of said venturi.

The invention also proposes a soup or emulsion of organic sludge obtained after N passages by recirculation in the reactor described above, with N≥2, advantageously≥3, or even higher than 7.

Advantageously, the organic sludge soup comprises at least 80% lysed bacteria. Such a result, which depends on the initial state, which may already be 20 to 30% lysis, has never been achieved to date.

The term “lysed bacteria” means bacteria whose cell membrane has been destroyed, causing its death.

It is also observed that during the first cycle of sludge treatment, the introduction of gas into the sludge associated with a short residence time of the mixture in the reactor (a few seconds), causes the extraction of small molecules, such as H₂S and NH₃ (toxic molecules), which promotes the increase in biodegradability during the following cycles.

The invention will be better understood upon reading the following description of embodiments given below by way of non-limiting examples. The description refers to the accompanying drawings wherein:

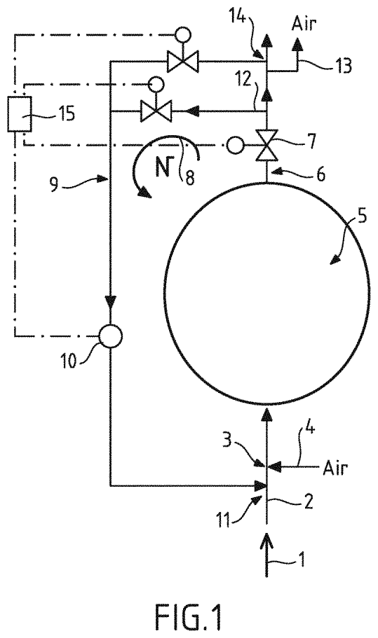

FIG. 1 is a schematic diagram showing the main iterative steps of the process according to the embodiment of the invention more specifically described herein.

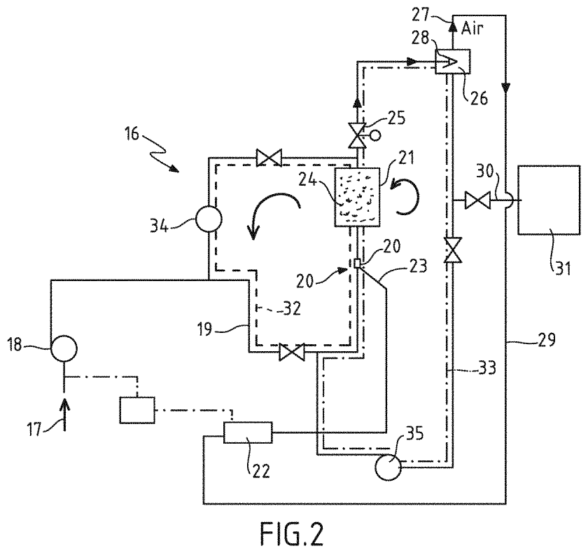

FIG. 2 is a schematic diagram illustrating an embodiment of a device implementing the process according to the invention in its two reiterative configurations.

FIG. 2A shows a cross-sectional view of an embodiment of an ejector that can be used with the invention.

FIGS. 2B to 2F show other embodiments of ejectors that can be used according to the invention.

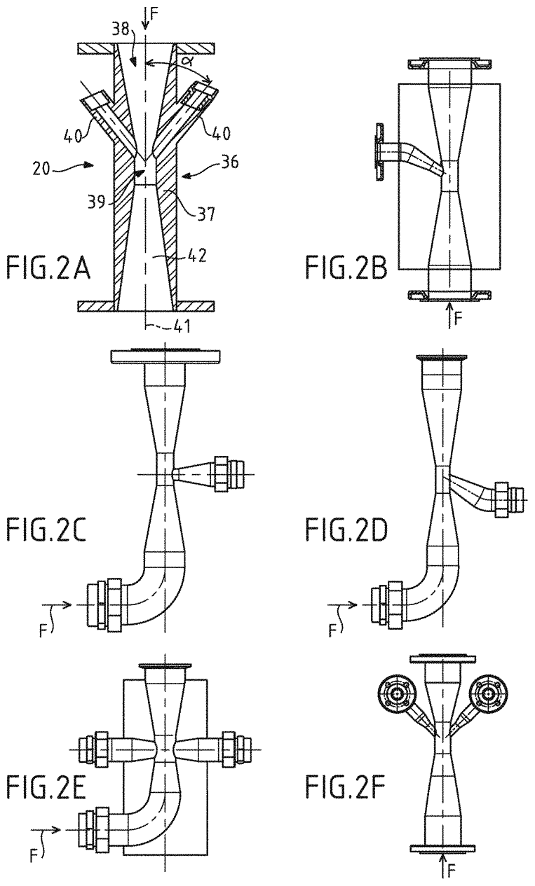

FIG. 3 shows a schematic cross-section of the degasser of the device according to an embodiment of the invention.

FIGS. 3A and 3B are front and cross-sectional views along IIIA-IIIA of an embodiment of the degasser of the type described with reference to FIG. 3.

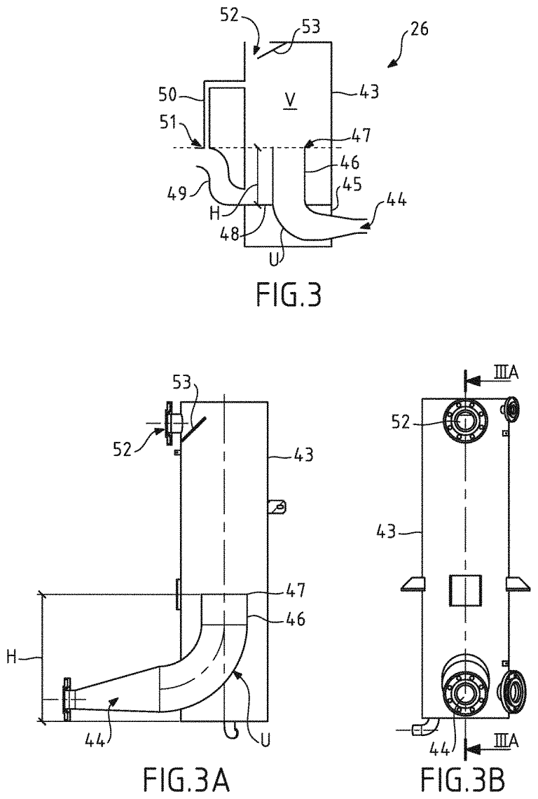

FIGS. 4 and 4A are top and cross-sectional views along IVA-IVA of another embodiment of the degasser with braking wall.

FIG. 4B is a schematic cross-sectional view of another embodiment of the degasser with braking wall.

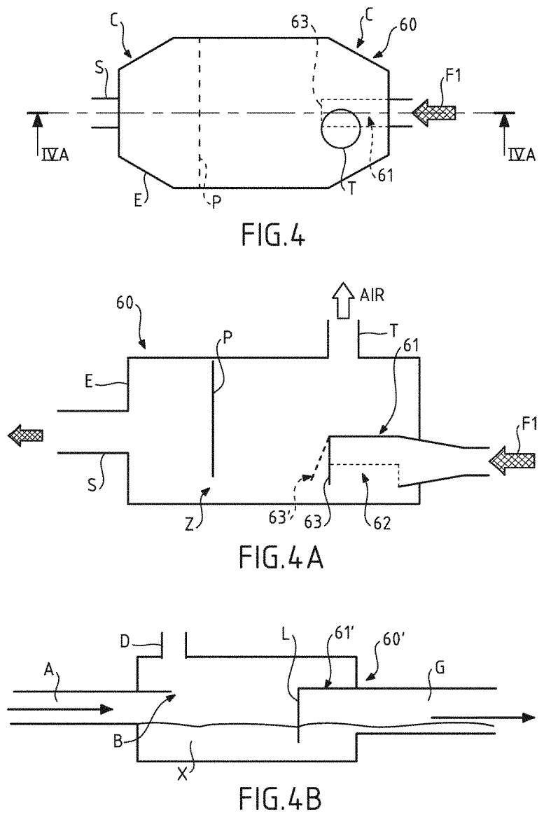

FIG. 5 illustrates the dispersion of the organic material, the analysis of which (dispersion, distribution, bursting) shows the increase in the biodegradability of said organic material, without implementation of the process according to the invention, and after circulation, one, eight and ten times according to the invention, on a liquid slurry.

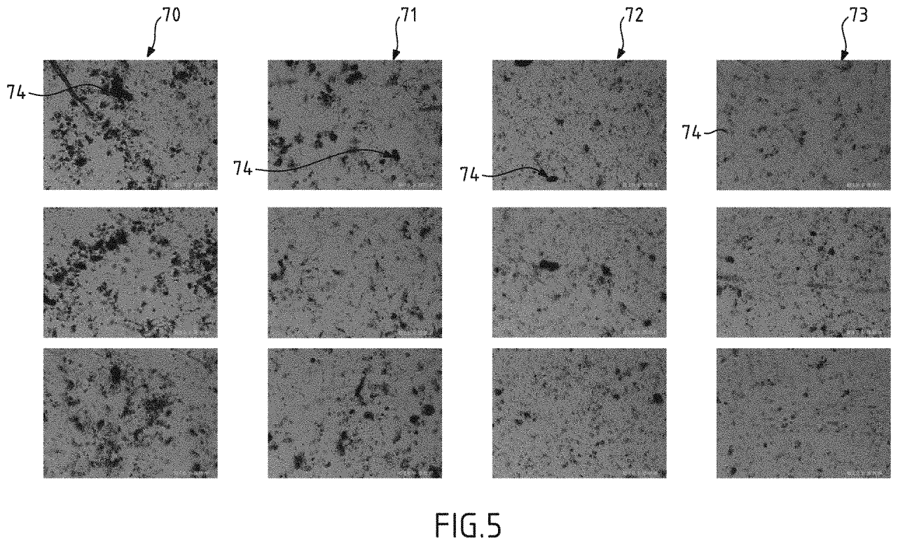

FIG. 6 illustrates the porosity, size and geometry of the bacterial structures (aggregates) and the lysis obtained after none, one and eight repetitions of the cycle according to the embodiment of the invention more specifically described herein on a liquid sludge.

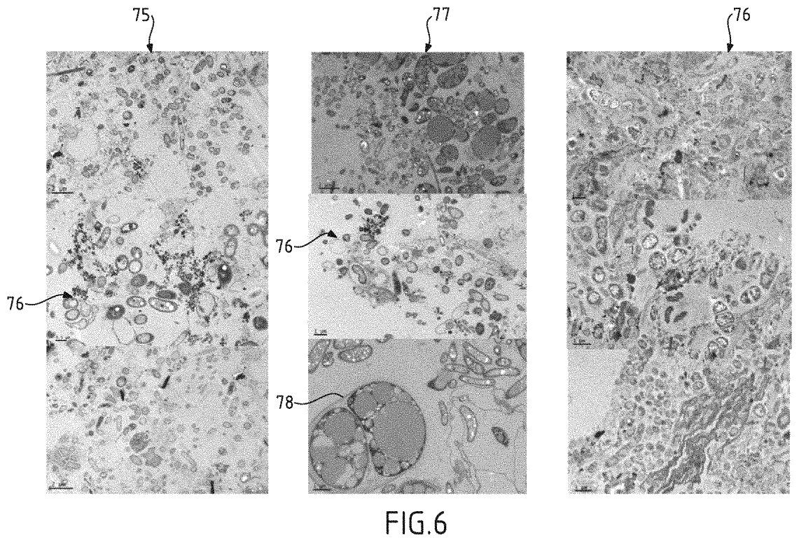

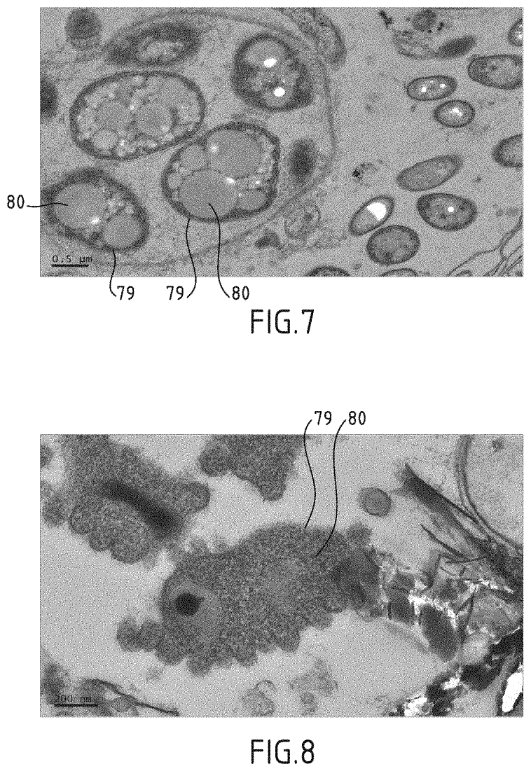

FIGS. 7 and 8 illustrate respectively a group of bacteria in the process of destruction enlarged to 0.5 micron, and bacteria completely lysed to 0.2 micron, respectively after eight repetitions.

FIG. 1 schematically illustrates a device implementing the process of increasing the biodegradability of sludge, according to the embodiment of the invention more specifically described herein.

From organic sludge 1, for example continuously pumped into a settling tank (not shown) and introduced into a pipe 2, a first hydrolyzed sludge emulsion is created in a first zone 3 (called the reduced zone) of the pipe, by injection of a gas 4 into the reduced zone, by imparting to the sludge emulsified in said zone a high speed V1 (V1≥10 m/s) and advantageously V1≥20 m/s.

The reduced zone 3 is therefore a zone of low pressure P1 (for example P1≤0.5 bar relative) and high speed allowing an excellent gas/sludge mixture.

The first emulsion is then introduced into a second zone 5, called the expansion zone or reactor, with a larger volume, imparting to the first emulsion a low speed V2 (≤1 m/s) but under a high pressure P2 (P2≥5 bar).

Zone 5 (or reactor) then opens continuously into a third zone 6, called the restriction zone, for example formed by a control valve 7, for discharging the first emulsion, at low pressure P3 (P3≤0.05 bar) and high speed V3≥20 m/s wherein a second emulsion is formed which will be recycled (arrow 8) at least once, or even N times with N≥2, for example 3 times or 7 times, via a bypass pipe 9 and a recirculation pump 10 located upstream from the first reduced zone 3.

This recirculation can take place via a port 12 located upstream of a degasser 13 of the second emulsion, or downstream 14 of said degasser, in a manner controlled by an automatic controller 15 as a function of the number N of cycles chosen.

Each cycle of emulsion circulation between the reduced zone 3 and the restriction zone 6 is equivalent to a passage time (and therefore gas bubble/sludge contact time), in particular in the reactor, of a few seconds, for example a time t≤10 s.

The emulsion, enriched with gas/air at each passage, is thus made to pass through successive phases of decompression/compression/decompression or acceleration/deceleration/acceleration of the emulsion at the same time t, thus imparting to said emulsion a treatment of lengths t+N×t.

It is also noted that the process according to the invention allows a thickening of the sludge ultimately obtained after decantation (when the emulsion is left to rest for further treatment, for example with a view to methanization) while maintaining a high availability of substrates. It is observed that it generates a low viscosity while allowing a partial lysis of aerobic bacteria, thus achieving the object of the invention, i.e., by increasing the biodegradability of the sludge, as it results from an analysis of bacterial development type in a Petri dish (see Table I below) given by way of example and obtained with sludge of the following composition

Volatile matter (VM) % of dry matter: 60%

Volatile fatty acids (VFA): 185 mg/l

AGC/TAC: 0.4

PH: 6.8

TABLE I

| | E. coli | Total flora |
|---|---|---|
| Sample | (CFU/g) | (CFU/g) |
| Sludge | 31 000 | 41 000 000 |
| No passage | | |
| Sludge | 79 000 | 89 000 000 |
| 2 passages (20 sec) | | |
| Sludge | 170 000 | 730 000 000 |
| 8 passages (80 sec) | | |
| Sludge | 25 000 | 14 000 000 |
| No passage | | |
| Sludge | 220 000 | 120 000 000 |
| 2 passages (20 sec) | | |
| Sludge | 330 000 | 320 000 000 |
| 8 passages (80 sec) | | |
| Sludge | 79 000 | 16 000 000 |
| No passage | | |
| Sludge | 320 000 | 130 000 000 |
| 2 passages (20 sec) | | |
| Sludge | 410 000 | 310 000 000 |
| 8 passages (80 sec) | | |
| Sludge | 36 000 | 32 000 000 |
| No passage | | |
| Sludge | 84 000 | 110 000 000 |
| 2 passages (20 sec) | | |
| Sludge | 140 000 | 130 000 000 |
| 8 passages (80 sec) | | |

CFU = colony forming units

FIG. 2 shows an embodiment of a device 16 according to the invention.

The liquid organic sludge 17 is introduced via a feed pump 18 and a pipe 19 to a restriction 20 for example formed by a venturi in a tubular enclosure 21 for example of 1 m height and 50 cm diameter.

A compressor 22 feeds compressed air 23 to the inside of the venturi 20, at an angle of 45° in the direction of the fluid, to form an emulsion 24 or three-phase sludge/air/water mixture.

The tubular enclosure is for example maintained at a pressure of the order of 3 bar to 5 bar relative.

This can be done via a valve 25 regulated according to the internal pressure of the chamber. This valve 25 constitutes a restriction.

Downstream of the valve 25, the emulsion feeds the degasser 26 according to the embodiment of the invention more specifically described herein.

The emulsion degasser is open to atmospheric pressure in 27 and comprises a vertical emulsion fountain feed tube 28 allowing a soft impact of the emulsion on itself, which allows a gentle and non-destructive degassing of the emulsion, as will be more fully described hereinafter with reference to FIGS. 3 to 3B.

The gas obtained may or may not be reused (circuit 29) to be recycled via the compressor 22, in the restriction zone 20.

The sludge remains inside the degasser for a given time, for example of the order of 1 to 5 minutes, and is then discharged by gravity via a pipe 30 to a subsequent treatment 31.

According to the embodiment of the invention, more specifically described, the tubular enclosure 21 will be recirculated several times before degassing (dashed circuit 32), or after degassing (dot-dashed circuit 33) via the recirculation pumps 34 and 35, respectively. FIG. 2A shows an embodiment of the restriction 20 in which the sludge/gas emulsion is produced.

The restriction is formed by a venturi 36 comprising a hollow body 37 comprising a sludge inlet (flow F) formed by a truncated conical bore 38 opening onto a cylindrical bore portion 39 of small diameter, in which two symmetrical ports 40, forming an angle comprised between 20° and 90°, for example 30°, with the axial direction 41 of the venturi, allow the feeding of gas in the direction of the sludge flow F.

The sludge/gas emulsion takes place in this cylindrical bore portion, for example with a volume of 1 liter, for a sludge flow rate of 50 m³/h and an injected gas, advantageously air, flow rate of 250 Nm³/h.

The cylindrical bore portion opens onto a reverse truncated cone portion 42 for discharging the emulsion towards the enclosure/reactor 21.

The configuration of this venturi and of the ports allows emulsion speeds higher than 20 m/s.

FIGS. 2B to 2F show the embodiments of a venturi with gas injection in the center of the venturi, with one counter-flow sludge port, for example at an angle of 45° (FIG. 2B), one port perpendicular to the direction of flow (FIG. 2C), a single port in the direction of flow, for example at an angle of 45° (FIG. 2D), two symmetrical ports perpendicular to the direction of flow (FIG. 2E), or two symmetrical counter-flow ports (FIG. 2F) for example at an angle of 45°.

FIG. 3 shows a schematic cross-section of the degasser 26 according to an embodiment of the invention.

The degasser comprises a container 43, for example cylindrical, with a height approximately equal to 1 m.

The diameter of the container is for example comprised between 200 and 300 millimeters.

The sludge is fed in 44 by a pipe, for example with a diameter of 80 mm, which penetrates the lower part 45 of the container and then has a 90° U bend and a vertical cylindrical part 46, for example with a diameter of 100.

The vertical cylindrical part 46 ends in a neck 47 for the outlet of the sludge in a fountain.

The container defines an internal volume V into which the cylindrical pipe 46 opens.

The volume has a bottom 48 provided with an outlet pipe 49 of the same diameter as the inlet pipe for the emulsion.

Advantageously, a port 50 for additional degassing of the emulsion after passage into the container, in the upper part 51 of the discharge pipe, is provided, said upper part 51 being at a lower height than the level of sludge in the container.

The height of the upper part 51 is arranged to be equal to or slightly lower than that of the neck 47, in relation to the bottom of the volume V, to allow a determined residence time in the degasser, for example 20 s.

The volume V ends at the top with an outlet opening 52 to the atmosphere, which is advantageously protected by a spoiler 53 for blocking sludge projections. In the embodiment as described and with the inlet/outlet dimensions of the various feed pipes of DN 80 mm, the height H of the sludge emulsion, i.e., between the bottom of the container and the periphery of the neck of the vertical cylindrical part 46, is for example comprised between 400 and 600 mm, for example 500 mm.

Hereinbelow, identical reference numbers will be used to designate the same or similar elements.

FIGS. 3A and 3B show another embodiment of a degasser according to the invention allowing the emulsion to be degassed by soft impact of the emulsion on itself.

It can fit into a parallelepiped of 1.50 m×1 m×600 mm, for the treatment of sludge fed continuously at a flow rate of 20 m³, using pipes and/or sheets of plastic or steel of the trade, which is a great advantage.

Indeed, compared with simple degassing by venting, or even compared with a degasser using mechanical stirring to detach the excess air from the emulsion, an improvement in degassing of up to 20% or even 50% is obtained.

Thus, for example, with a device of the type described in FIG. 3, of 64 1 maximum useful volume (square base of 400 mm×2.5 mm), an inlet elbow of DN 120 mm and an operation between 5 to 12 m³/h (with an air flow rate of 30 Nm³/h), a better degassing is obtained, and this much faster than with the prior art. This is shown in Table II below, which also specifies the conditions for the head of the fountain H (conditioning the soft impact).

TABLE II

| | Useful volume (l) | Elevation of the |
|---|---|---|
| | and useful | fountain with |
| | residence time | respect to the |
| Flow rate (m³/h) | (s) | bottom (H) |
| 5 | 58/42 | 35 to 40 |
| 5 | 58/42 | 35 to 40 |
| 5 | 58/42 | 35 to 40 |
| 10 | 60/22 | 40 to 45 |
| 10 | 60/22 | 40 to 45 |
| 10 | 60/22 | 40 to 45 |
| 12 | 62/19 | 45 to 50 |
| 12 | 62/19 | 45 to 50 |
| 12 | 62/19 | 45 to 50 |

FIGS. 4 and 4A show a top view and a cross-section along IVA-IVA, an example of a degasser 60 according to another embodiment of the invention, comprising an enclosure E, for example of parallelepipedal shape with cut corners C, arranged horizontally with respect to the arrival of the sludge flow F, for example of dimensions L×1×H: 300×400×300 for a treatment flow rate of 10-13 m³/h, a TS of 8 to 10 g/l and a V_{eff} of 30 liters.

V_{eff} (effective volume) is a volume of sludge/water at the inlet of the degasser allowing the energy necessary for a good degassing of the emulsion to be absorbed.

This volume varies according to the different sizes.

It is about, for example, 30-40 liters.

The enclosure E comprises a flow inlet which opens into a passage chamber 61, for example cylindrical, having a cylindrical portion 62 open at the bottom, over the entire length of the chamber (for example 200 mm in the above numerical example) and provided at its end in the horizontal direction with a wall 63, suitable for braking the emulsion or when the wall is flexible for moving away inwards 63′ under the gentle pressure of the emulsion F1.

The enclosure has a tube T at the top for discharging the air from the degasser, and an outlet orifice S at the other end. The enclosure E may or may not have, for example at ⅔ of its length, an intermediate distribution wall P, allowing the emulsion to be discharged at the bottom, through a widened slit Z.

Such a wall allows either direct braking of the emulsion, or further reinforces the homogeneity of the emulsion.

FIG. 4B shows a variant of the degasser 60′ according to another embodiment of the invention, in longitudinal direction.

The inner wall intended to absorb the impact of the mixture can advantageously be made of rubber or another soft material. However, a more rigid wall can also be used, for example one with a more or less convex shape.

More specifically, the variant of FIG. 4B shows an inlet A for the emulsion and excess gas into a zone B of the enclosure 60′ filled with sludge X at the bottom and gas at the top.

The zone B is closed by a wall L which absorbs the energy of the flow, a soft or hard wall (advantageously convex).

The excess gas is removed from the gas stream by a venting D.

The extraction of the liquid flow under pouring by the wall L is done by the zone G which provides a calm, laminar flow.

For 20 to 23 m³/h of sludge charged between 10 and 30 g/l and up to 100 Nm³/h of air added to form the emulsion, the enclosure is for example of dimensions L×1×H=500×200×250 with a penetration in the enclosure of the outlet tube of 130 mm and an absorbing wall height of 160 cm.

With the invention (see photographs in FIG. 5) a dispersion of the material is observed which improves with each passage, in comparison with the absence of treatment according to the invention.

More precisely, columns 70, 71, 72 and 73 show the dispersion of the organic material 74 respectively after zero passages, one passage, eight passages and ten passages. It can be seen that the material is more and more dispersed as the passages go on (until it does not change too much from 7.8 passages onwards), which therefore makes the bacteria more available for the rest of the process, for example, to be directed towards a digester.

In addition to their dispersion, a destruction of the walls of the bacteria is observed in a particularly favorable way (destruction of the membrane walls; see FIG. 6), which makes their contents accessible and consumable by other bacteria, thus and globally leading with their dispersion to a better biodegradability.

With no passage (column 75), the bacteria 76 are alive. After one or two passages (77) the lysis rate of bacteria 76 is already above 30% (see destruction of membranes 78).

After eight passages, the destruction rate (lysis) is greater than or equal to 80%.

The photographs of FIGS. 7 and 8 show respectively at the scale of 0.5 micron and 0.2 micron, the destruction of the membranes 79 of bacteria 80, giving access to their contents, and thus showing their biodegradability, after 8 passages.

The implementation of the process according to the embodiment of the invention more specifically described here will now be described with reference to FIG. 2.

The sludge 17 is fed continuously by pumping at a flow rate Q, for example of 20 m³/h, into a pipe, for example of diameter DN50 and length L equal to a few meters. At the same time, a large flow of air, for example 60 Nm³/h, is continuously injected into the venturi 20, which creates the three-phase emulsion, which then enters the enclosure 21 in suppression. The emulsion then passes through the restriction 25, for example a valve, causing a new pressure/depression impact.

The emulsion is recycled upstream of the degasser N times by means of the automatic system (circuit 32).

The emulsion then rains into the degasser 26.

The soft impact of the emulsion on itself allows a good and gentle degassing which remains, considering the dimensions of the bent tube, the volume V and the flow rates, only for a few seconds (to a few minutes) in the container before being discharged, with an increased biodegradability.

The emulsion can then be recycled downstream of the degasser, for example by reusing the excess degassed air. The emulsion is then transferred for example by gravity or by pumping (it has very low viscosity) for further treatment.

As is obvious and as is also evident from the foregoing, the present invention is not limited to the more specifically described embodiments. On the contrary, it embraces all the variants and in particular those in which the whole device is mobile, for example by being mounted on a truck trailer, given its very great compactness. This allows it to be transported from one site to another as required.

1. A process for improving the biodegradability of organic sludge (1, 17) comprising at least two successive treatment cycles, each cycle having a total duration comprised between the order of 8 s and the order of 20 s, each cycle comprising a first step of creation of a first hydrolyzed sludge emulsion in a first zone (3, 20, 39), called the reduced zone, by injection of a gas (4, 23) into said reduced zone, a second step of sudden expansion of the emulsion in a second zone (5, 21), called the expansion zone, and a third step of recovery of the emulsion via a third zone (6, 25), called the restriction zone.

2. The process for improving the biodegradability of a sludge as claimed in claim 1, wherein the sludge (1, 17) and the gas are injected into the reduced zone (3, 20, 39) by imparting to the sludge in said reduced zone a first speed V1 greater than 20 m/s and a first relative pressure P1, sudden expansion of the emulsion is performed in the expansion zone (5, 21) at a second relative pressure P2 greater than 2 bar, then the emulsion is recovered in the restriction zone by imparting to said emulsion in said restriction zone (6, 25) a second velocity V2 greater than 20 m/s.

3. The process as claimed in claim 2, characterized in that the first zone (3, 20, 39), called the reduced zone, being an element of small diameter d (d<50 mm) in which the sludge passes at the first high speed V1 and at low pressure p1, gas or air is injected at a high flow rate (for example at a flow rate q Nm³≥10 Q m³, Q being the sludge flow rate), is injected to create the gaseous, compressible emulsion, which is then fed to the second downstream zone or reactor with a larger diameter D (D>20 d) than the element in which the emulsion passes, at a higher pressure P2 (P2>10 P1) and at a lower velocity v (v<10 V1), before undergoing a pressure drop in the downstream restriction zone (6, 25), by imparting to said emulsion in said restriction zone the second velocity V2≥20 m/s.

4. The process as claimed in claim 1, characterized in that the gas is air.

5. The process as claimed in claim 1, characterized in that the cycle is repeated at least N times with N≥2.

6. The process as claimed in claim 5, wherein N≥7.

7. The process as claimed in claim 1, characterized in that the first zone being the central part of a venturi (20, 36) elongated about an axis (41) parallel to the direction of feed of the sludge, the air is injected into said central part obliquely with respect to the axis of the venturi.

8. The process as claimed in claim 2, characterized in that the average pressure in the second zone is P2>3.5 bar and in that the pressure downstream of the restriction zone is a third pressure P3 equal to atmospheric pressure.

9. The process as claimed in claim 1, characterized in that the emulsion is strongly degassed after the third zone before repeating.

10. The process as claimed in claim 9, characterized in that the emulsion is degassed by soft impact of the emulsion on itself or on an energy-absorbing flap (63, U) for braking the emulsion.

11. The process as claimed in claim 1, characterized in that the gas is injected in the direction of flow at an angle comprised between 20° and 50° with the direction of flow.

12. A device (16) for improving the biodegradability of organic sludge (17) comprising a pressurized in-line container (21), means (18) for feeding the container with the sludge continuously comprising a venturi (20) for the passage of the sludge, elongated around an axis, at least one air injection port (23) in the narrowing of said venturi for injection at an angle to the axis arranged to create an emulsion in the container and means for discharging the emulsion from said container via a member (25) generating a pressure drop, and means (32, 33, 34, 35) for circulating said emulsion in a loop in the container by the sludge feeding means, upstream of the injection of air (23) into said emulsion by said sludge feeding means.

13. The device as claimed in claim 12, characterized in that it comprises at least one air injection port (40) in the venturi at an angle comprised between 20° and 50° to the axis of the venturi.

14. The device as claimed in claim 12, characterized in that it comprises means (26, 60) for degassing the emulsion at atmospheric pressure by soft impact of the emulsion on itself or on an energy-absorbing flap (63, U).

15. An organic soup obtained from the process as claimed in claim 1, characterized in that it comprises at least 80% lysed bacteria.
